(19) United States
(12) Patent Application Publication
(10) Pub. No.: US 2014/0075863 A1
(43) Pub. Date: Mar. 20, 2014

(54) ADJUSTABLE POCKET DOOR FRAME

(71) Applicant: RICHELIEU HARDWARE LTD, Kitchener (CA)

(72) Inventor: Mark LARONDE, Breslau (CA)

(73) Assignee: RICHELIEU HARDWARE LTD, Kitchener (CA)

(21) Appl. No.: 13/961,206

(22) Filed: Aug. 7, 2013

Related U.S. Application Data
(60) Provisional application No. 61/702,358, filed on Sep. 18, 2012.

(51) Int. Cl. E06B 1/04; E06B 1/52

(52) U.S. Cl. CPC E06B 1/045; E06B 1/52
USPC 52/217

(57) ABSTRACT

A pocket door frame includes a slat having a first end and a second end. The slat is adjustable in length. The pocket door frame includes a spine member attached to the first end of the slat and a jamb member attached to the second opposite end of the slat. A method is provided for installing a pocket door frame. The method includes adjusting the length of a slat having a first end attached to a spine member and a second end attached to a jamb member.

### CROSS REFERENCE TO RELATED APPLICATIONS

This application claims priority from U.S. Provisional Application No. 61/702,358 filed Sep. 18, 2012, which is incorporated herein by reference.

### FIELD

The present disclosure relates generally to pocket door frames. More particularly, the present disclosure relates to pre-built adjustable pocket door frames.

### BACKGROUND

In the construction of buildings, such as houses, apartments, condominiums or office buildings, the internal space is typically divided into different sized rooms. In order to move between these rooms, doors are needed. In some setups, the doors open and close due to hinges which are mounted to the wall. In other situations, the door may be pocket door which is a sliding door wherein, when the door is fully opened, it is contained within a frame in a wall.

In order to install a pocket door, a frame must be built to accommodate the door when the door is open. The frame creates a space within a wall for the pocket door to be housed. Conventional pocket door frames are currently available in kits that are assembled by the installer or pre-built, however, these pre-built models are created to match the size of the door. The pre-built models are one size only depending on the size of door being accommodated by the frame. For example, current pocket door frames are pre-built for one of 24 inch, 28 inch, 30 inch, 32 inch or 36 inch doors.

In order to provide pre-built pocket door frames for these standard size doors, a retailer must carry all five sizes of pre-built door frames. This results in a large amount of storage space required for stores to maintain enough stock, especially hardware stores.

It is, therefore, desirable to provide an adjustable pocket door frame.

### SUMMARY

It is an object of the present disclosure to obviate or mitigate at least one disadvantage of previous systems.

In a first aspect, the present disclosure is directed at a pocket door frame including a slat having a first end whereby a second end and the slat is adjustable in length. The pocket door frame includes a spine member attached to the first end of the slat and a jamb member attached to the second end of the slat.

In an aspect, the slat includes a first member attached to only one of the spine member or the jamb member and a second member attached to the other of the spine member or the jamb member. The first member may have a sliding mechanism that accommodates a sliding mechanism of the second member. In a further aspect, the sliding mechanism of the first member is a dovetail and the sliding mechanism of the second member is a groove corresponding to the dovetail.

In another aspect, the jamb member includes a pair of split jamb members and the pocket door frame also includes a pair of slats attached to each of the pair of the split jamb members. The pocket door frame may further include at least one transport block joining the pair of split jamb members.

In an embodiment, the pocket door frame includes a plurality of the adjustable slats. In this case, each slat has a first end attached to the spine member and the second end attached to the jamb member.

In certain aspects, the pocket door frame includes a header assembly that is cut to length. The header assembly may include a track for engaging at least one door hanger, a pocket end having a nailing strip, and a header member. The pocket end and the header member may have at least one cutting guide.

In another aspect, the present disclosure provides a method for installing a pocket door frame. The method includes adjusting the length of a slat having a first end attached to a spine member and a second end attached to a jamb member.

In a further aspect, the method includes securing the spine member to a wall frame and removing a transport block from the jamb member. The method may also include cutting along a header cutting guide on a header member, cutting along a pocket end cutting guide on a pocket end, and trimming a track a predetermined amount. The method may also include installing the header member, the pocket end, and the track to a door frame.

In an aspect, the method includes attaching at least one door plate to a top surface of a door, inserting a door hanger into the track, and attaching the door plate to the door hanger.

Other aspects and features of the present disclosure will become apparent to those ordinarily skilled in the art upon review of the following description of specific embodiments in conjunction with the accompanying figures.

### BRIEF DESCRIPTION OF THE DRAWINGS

Embodiments of the present disclosure will now be described, by way of example only, with reference to the attached Figures.

FIG. 1 is a perspective view of a pocket door;

FIGS. 2 to 4 are illustrations of an adjustable pocket door, in accordance with at least one embodiment;

FIGS. 5 and 6 are illustrations of a horizontal slat, in accordance with an embodiment;

FIGS. 7 and 8 are illustrations of a header assembly, in accordance with an embodiment; and

FIG. 9 is a flow chart of a method for installing a pocket door, in accordance with an embodiment.

### DETAILED DESCRIPTION

Generally, the present disclosure provides a method apparatus and system for a pre-built adjustable pocket door frame. The pre-built adjustable pocket door frame provides an advantage over current door frames in that stores may not need to store as many pre-built pocket door frames than currently necessary as the size of door which can be received by the current disclosure is variable. As current pre-built door frames are manufactured for at least five (5) different sized doors, a storage space savings of about 80% may be realized. For instance, if a store wanted to have ten (10) sets of pocket doors in storage for the five sizes, namely, 24 inch, 28 inch, 30 inch, 32 inch or 36 inch doors, fifty (50) pre-built pocket door frames are need. Using the described adjustable pocket door frame, while fifty doors are in storage, only ten (10) adjustable pre-built pocket door frames are needed to have 10 pocket doors packages available for each size.

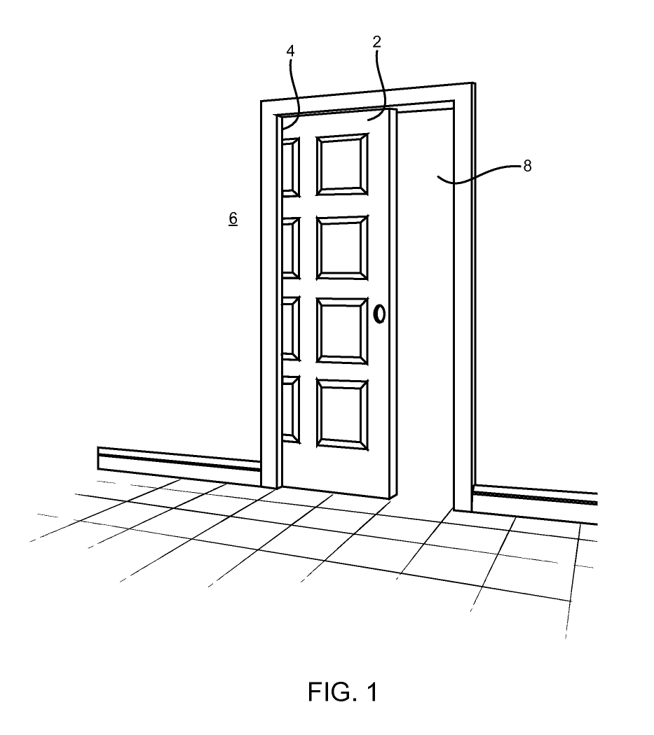

FIG. 1 is a perspective view of a pocket door. The pocket door 2 is located in a door support frame 4 while a pocket door frame (not shown) is housed within a wall 6. In use, the pocket door 2 slides into and out of the pocket door frame between open and closed positions within a door opening 8.

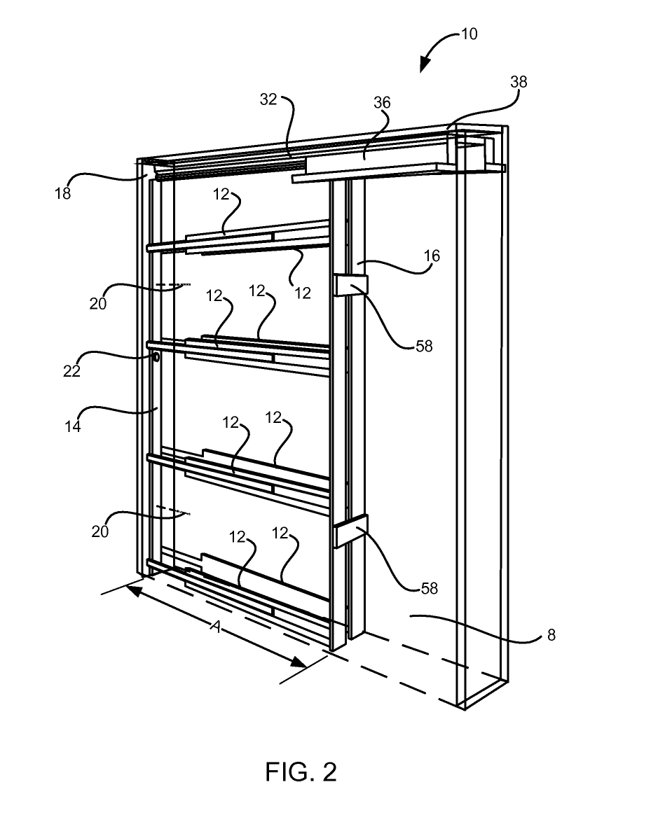

FIGS. 2 to 4 illustrate an embodiment of a pre-built adjustable pocket door frame. In this embodiment, the adjustable pocket door frame 10 includes a set of horizontal slats 12, a spine 14, and a jamb portion 16 which may be a pair of split jambs 17. The spine 14 is fastened to a rough frame 18, or header, within the wall 6 by a fastener such as, but not limited to, screws 20. The spine 14 may have a bumper 22 such as a rubber pad which reduces the possibility of damage to the door 2 or spine 14 when the door 2 is fully opened.

The horizontal slats 12 may be arranged in pairs with one horizontal slat of each pair aligned with one of the pair of split jambs 17a and 17b. One end of the horizontal slat 12 is affixed to and extends from the spine 14 while the other end of the horizontal slat 12 is affixed to and extends from its corresponding jamb 17a or 17b. When installing the pocket door frame 10 within a wall 6, the horizontal slats 12 allow for a user to adjust the width of the pocket door frame 10 as will be described below. Adjusting the width of the pocket door frame 10 allows for accommodation of the particular width of the door 2 that is to be installed.

By being able to adjust the width of the pocket door frame 10, doors in standard sizes (for example, 24 inch, 28 inch, 30 inch, 32 inch, and 36 inch) may be accommodated. Furthermore, the pre-built adjustable pocket door frame may also accommodate a door of any size in between or outside the standard sizes based on the basic structure of the door frame.

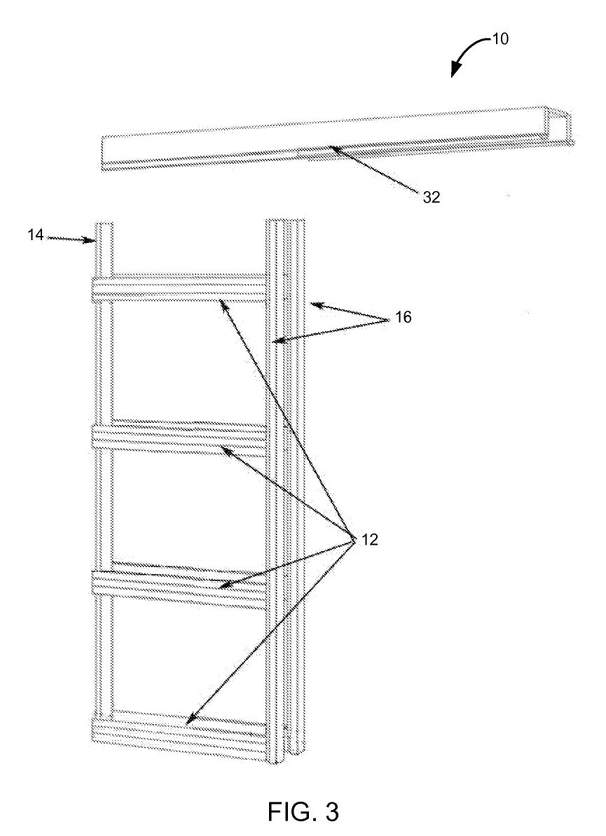

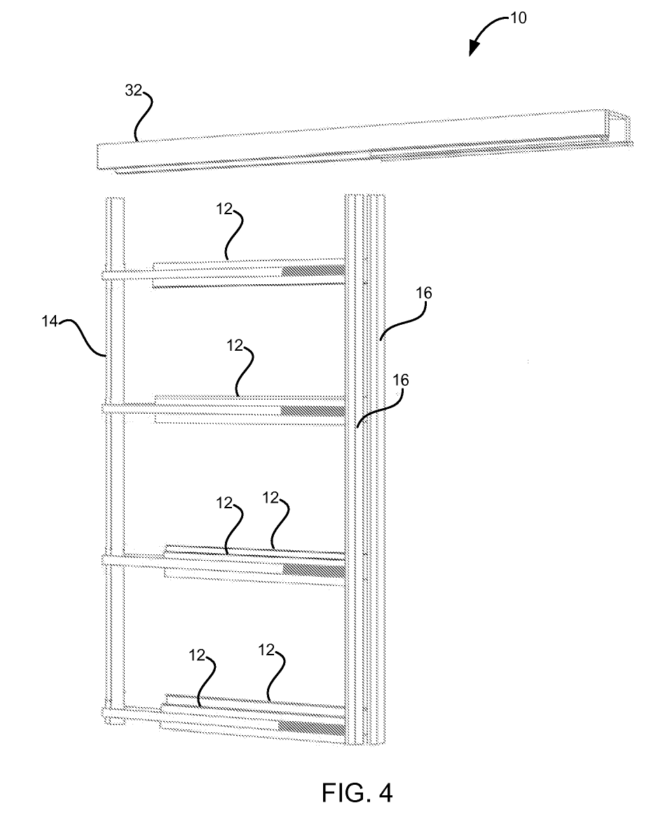

The horizontal slats 12 are configured to be adjustable in the direction of arrows A, thereby allowing the distance between the jamb portion 16 and the spine 14 to be increased or decreased in accordance with the width of the door being accommodated. FIG. 3 illustrates the horizontal slats 12 in a first, such as a retracted, position representing the smallest possible frame size while FIGS. 2 and 4 illustrate the horizontal slats 12 in extended positions showing the frame's ability to accommodate other door sizes.

The pre-built adjustable pocket door frame 10 may also include a header portion 32. The header portion 32 may be attached to a track 34 which is installed in the header housing and a pocket end 36 and installed to a rough header 38 on the wall 6. The entire header housing may be seen as being secured to the inside top of the rough stud door opening.

As shown in FIG. 2, the pre-built adjustable pocket door frame 10 may come with transport blocks 58 to add stability while the pocket door frame is transported and during installation. The transport blocks 58 may be removed once the pre-built adjustable pocket door frame 10 is installed so that the door 2 can pass through the pair of split jambs 17a and 17b when the door is operational.

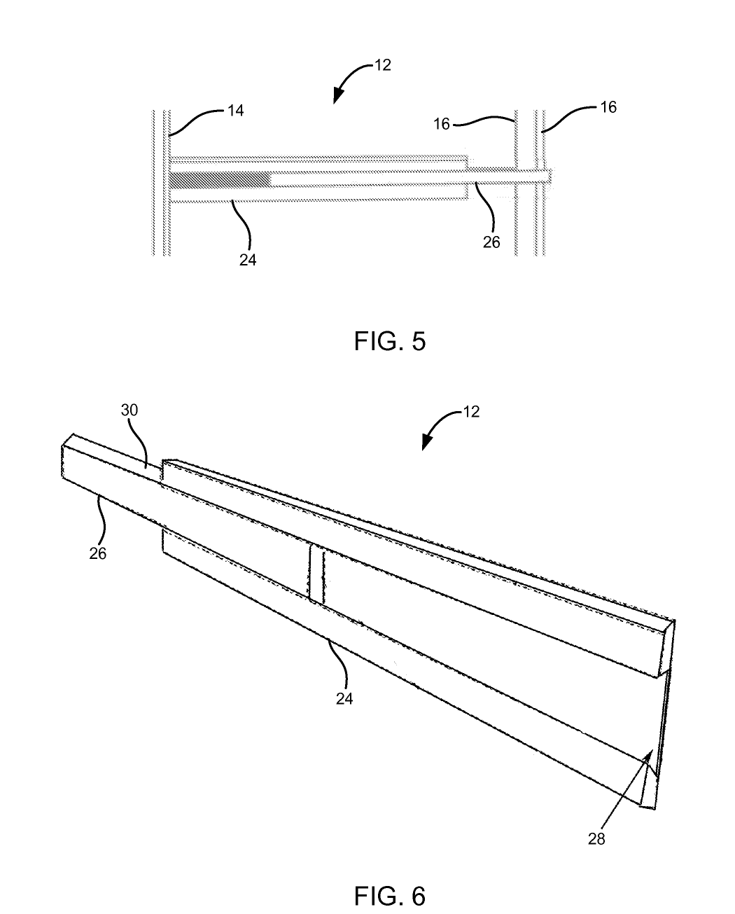

FIGS. 5 and 6 are, respectively, a front view and a perspective view of a horizontal slat. As shown, the horizontal slat 12 includes a first member 24 which includes a slot 25 for receiving a second member 26. In one embodiment, the first member 24 is connected to the spine 14 while the second member 26 is connected to the jamb portion 16. In an alternative embodiment, the first member 24 may be connected to the jamb portion 16 while the second member 26 is connected to the spine 14.

The slot 25 of the first member 24 accommodates the second member 26. The shape of the slot 25 may be designed to match the shape of the second member 26 such as via a set of matching grooves, like a dovetail type tongue and groove having a trapezoidal shape. The mating shapes of the first member 24 and the second member 26 allow the first member 24 and the second member 26 to slide with respect to each other to provide for movement (extension and contraction) in the horizontal direction. The interaction of the slot 25 and the second member 26 also reduces or prevents substantial bending of the horizontal slat 12 and provides stability to the pre-built adjustable pocket door frame 10.

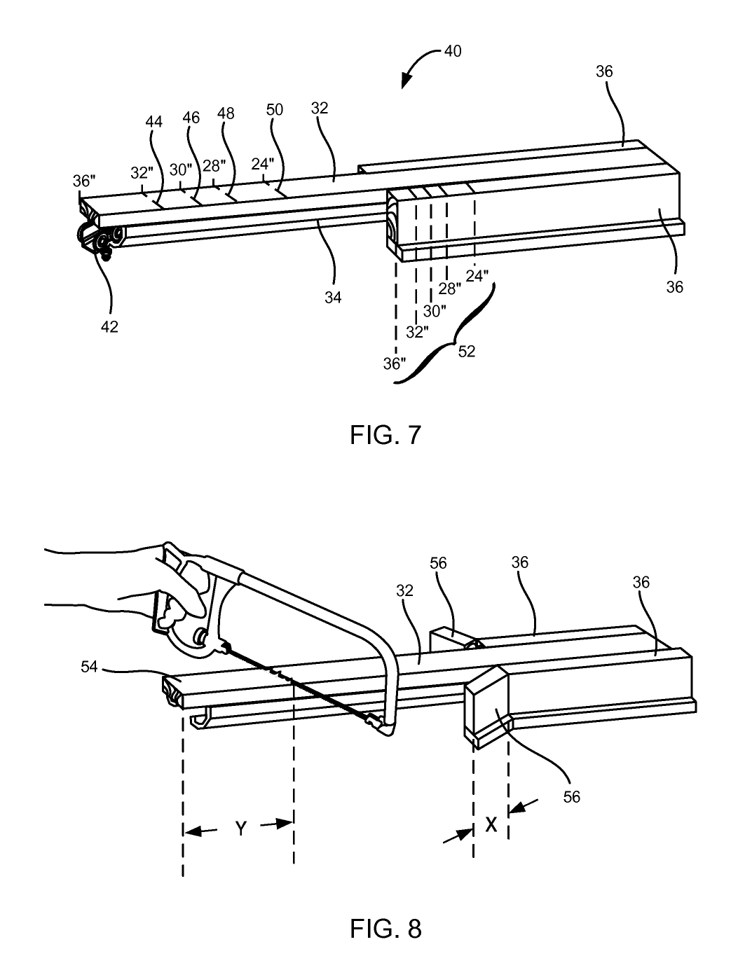

FIGS. 7 and 8 are perspective views of a header assembly in accordance with an embodiment. The header assembly 40 includes the header 32, the track 34, and the pocket end 36 which may be a nailing strip. The track 34 may include a surface for engaging door connectors 42 which are then affixed by a door plate to a top end of the door 2 thereby allowing the door 2 to roll along the track 34 into and out of the pocket frame 10.

The header 32 may include cutting guides 44, 46, 48, 50 to assist the user in adjusting the pocket door frame for the selected door width. In the current embodiment, the cutting guides may be for doors of width 32 inches, 30 inches, 28 inches, and 24 inches. Guides 44, 46, 48, 50 indicate where the header should be trimmed for each width of door installation. The header 32 is shortened when the door 2 to be installed is shorter in width then the maximum available size. Similar to the header 32, the pocket end 36 may include cutting guides 52 which indicate where the pocket end 36 may be trimmed for the size of the door 2 to be installed. The track 34 may also trimmed (for example, to be two (2) inches shorter than the header 32) to provide clearance for the spine 14.

As shown in FIG. 8, the header assembly 40 may be cut to accommodate the width of the door 2. In an alternative embodiment, the header assembly 40 may be cut according to a custom door size. In this case, the header 32 has an excess section 54 of length Y removed, and the pocket end 36 has an excess section 56 of length X removed from the center of the header assembly 40. The length of the pocket end 36 may be the width of the door 2 plus an increment (for example, 1⅛ inches). The length Y may then be calculated as twice the length X.

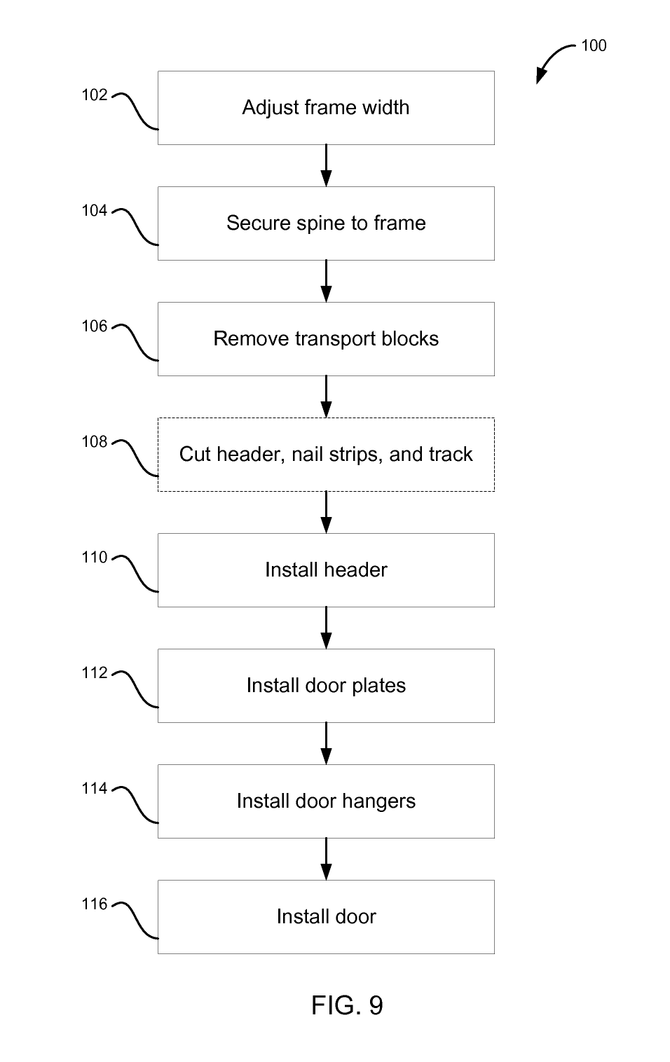

Turning to FIG. 9, a flowchart outlining a method 100 for installing a pocket door frame is provided. After the pocket door frame has been transported to the installation location, the horizontal slats are adjusted 102 according to the required frame width, to accommodate the selected door. The spine may then be secured 104 to the rough frame 18 with a set of fasteners, such as screws 20. The transport blocks 58 may then be removed 106 from the jamb portion 16.

If the header assembly 40 is too long, portions, such as the header, the pocket ends, the track, or any combination of these parts, are trimmed 108 along the appropriate cutting guide 44, 46, 48, 50. In an alternative embodiment, the header 32, the pocket ends 36, and the track are cut to a custom length and not based on the cutting guides.

After the pocket door frame has been trimmed to its required size, the header assembly 40 is installed 110 to the rough header 38. In one embodiment, the header assembly 40 is screwed from below directly into the rough header 38. The header assembly 40 may be leveled with shims.

At least one door plate is attached 112 to a top surface of the door 2. In one embodiment, the door plate is affixed to both ends of the top surface of the door 2. A door hanger 42 is then inserted 114 into the track 34 for each door plate allowing rollers to roll along the track 34 so that the door can move. The door plates are then attached 116 to the door hangers 42 and the door 2 is installed. In an embodiment the door hangers 42 are vertically adjustable such that the door 2 may be positioned to a desired vertical position.

In the preceding description, for purposes of explanation, numerous details are set forth in order to provide a thorough understanding of the embodiments. However, it will be apparent to one skilled in the art that these specific details are not required. The above-described embodiments are intended to be examples only. Alterations, modifications and variations can be effected to the particular embodiments by those of skill in the art without departing from the scope, which is defined solely by the claims appended hereto.

What is claimed is:

1. An adjustable pocket door frame comprising:
a jamb portion;
a spine portion; and
a set of slats, each of the set of slats connected at a first end to the jamb portion and at a second end to the spine portion;
wherein the slats allow the distance between the spine portion and the jamb portion to be altered.

2. The adjustable pocket door frame of claim 1 wherein each of the set of slats includes a first portion and a second portion, the first end associated with the first portion and the second end associated with the second portion.

3. The adjustable pocket door frame of claim 2 wherein the first portion slides within the second portion allowing the distance between the spine portion and the jamb portion to be adjusted.

4. The adjustable pocket door frame of claim 2 wherein the second portion slides within the first portion allowing the distance between the spine portion and the jamb portion to be adjusted.

5. The adjustable pocket door frame of claim 2 wherein the first portion includes a male protrusion portion and the second portion includes a female receiving portion matching a profile of the male protrusion.

6. The adjustable pocket door frame of claim 2 wherein the second portion includes a male protrusion portion and the first portion includes a female receiving portion matching a profile of the male protrusion.

7. The adjustable pocket door frame of claim 1 wherein the jamb portion comprises a pair of split jambs.

8. The adjustable pocket door frame of claim 7 each of the set of slats is connected at the first end to one of the pair of split jambs and at the second end to the spine portion.

9. The adjustable pocket door frame of claim 1 further comprising a header portion.

10. The adjustable pocket door frame of claim 9 wherein the header portion include cutting markings.

11. The adjustable pocket door frame of claim 1 further comprising a track assembly for receiving a door within the pocket door frame.

12. The adjustable pocket door frame of claim 1 further comprising apparatus for mounting the pocket door frame within a wall.

13. The adjustable pocket door frame of claim 1 wherein each of the set of slats comprises a sliding mechanism to allow the distance between the spine portion and the jamb portion to be altered.

14. The adjustable pocket door frame of claim 13 wherein the sliding mechanism is a set of matching grooves.

15. The adjustable pocket door frame of claim 14 wherein the set of matching grooves is a dovetail type tongue and groove having trapezoidal shape.
